(19) United States
(12) Patent Application Publication
(10) Pub. No.: US 2007/0100848 A1
(43) Pub. Date: May 3, 2007

(54) Node index

(76) Inventor: Peter Vignet, San Francisco, CA (US)

Correspondence Address: HOLLAND & KNIGHT, LLP, 10 ST. JAMES AVENUE, BOSTON, MA, 02116, US

(21) Appl. No.: 11/263,883

(22) Filed: Nov. 1, 2005

(51) Int. Cl. G06F 7/00

(52) U.S. Cl. 707/100

(57) ABSTRACT

Methods and apparatus, including computer program products, for a node index. A memory for storing data for access by an application program being executed on a data processing system includes a context node data structure stored in the memory, the context data structure including nodes and attributes, a selected attribute including a node index. The node index can include a key object and a value object. The value object can represent an object. The key object can represent a key attribute of an object.

### BACKGROUND

The present invention relates to data processing by digital computer, and more particularly to a node index.

Today's computer/network end users are accustomed to the Internet's intuitive point-and-click technology in user interfaces (UIs). In contrast to many professional business applications, Internet browsers often lack input checks, input help, support for multiple languages, and easy-to-use error handling. These shortcomings that are not acceptable for state-of-the-art Web applications.

One way to overcome these short comings is provided by SAG AG as Web Dynpro. Web Dynpro is an integral part of a SAP Web Application that provides a design-time environment that is independent of the underlying runtime environment and enables companies to model and design UI's cost-effectively and precisely. A Web Dynpro application includes a set of views, navigation between the views, concepts for managing the views and determining their sequence, a context for keeping session data, and the business logic of the application. Web Dynpro is modeled on a model view controller (MVC) paradigm that allows for a strict separation of presentation logic, business logic, navigation, and eventing. In object-oriented programming development, MVC is the name of a methodology or design pattern for successfully and efficiently relating a user interface to underlying data models. The MVC pattern is used in program development with programming languages such as Java, Smalltalk, C, and C++.

### SUMMARY

The present invention provides methods and apparatus, including computer program products, for a node index.

In general, in one aspect, the invention features a memory for storing data for access by an application program being executed on a data processing system including a context node data structure stored in the memory, the context data structure including nodes and attributes, a selected attribute including a node index.

In embodiments, the node index can include a key object and a value object. The value object can represent an object. The key object can represent a key attribute of an object.

In another aspect, the invention features a data processing system executing an application program and containing a database used by said application program, said data processing system including central processor unit (CPU) means for processing said application program, and memory means for holding a data structure for access by said application program, said data structure being composed of information resident in said database used by said application program and including a context node data structure stored in the memory means, the context data structure including nodes and attributes, a selected attribute including a node index.

In embodiments, the node index can include a key object and a value object. The value object can represent an object. The key object can represent a key attribute of an object.

Other features and advantages of the invention are apparent from the following description, and from the claims.

### BRIEF DESCRIPTION OF THE DRAWINGS

FIG. 1 is a block diagram of an exemplary system.

FIG. 2 is a block diagram of an exemplary node diagram.

FIG. 3 is a block diagram of an exemplary node diagram.

FIG. 4 is a block diagram of an exemplary node diagram.

FIG. 5 is a block diagram of an exemplary data structure.

FIG. 6 is a block diagram of an exemplary node diagram.

FIG. 7 is a block diagram of an exemplary node diagram.

Like reference numbers and designations in the various drawings indicate like

### DETAILED DESCRIPTION

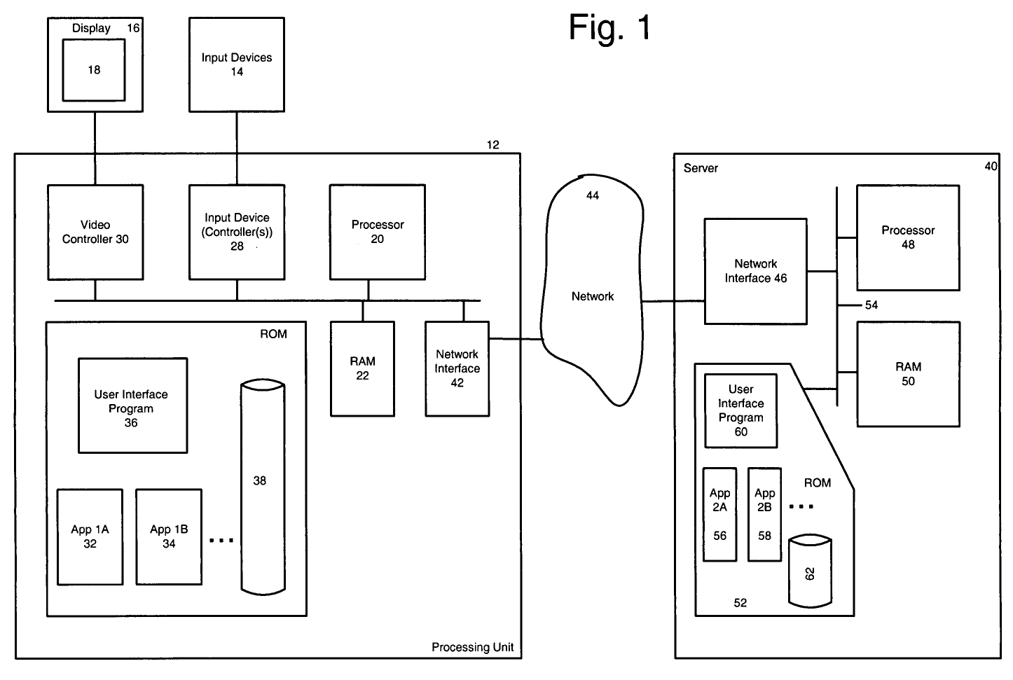

As shown in FIG. 1, an exemplary computer system 10 includes a processing unit 12, one or more input devices 14, and a display device 16, upon which a user is presented displays. The display device 16 has a video screen 18 upon which displays appear.

The processing unit 12 can include a processor 20, random access memory (RAM) 22, and read-only memory (ROM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16 so that the desired display is provided on the screen 18. The system 10 is not limited to a personal computer (PC), but could include a personal digital assistant (PDA), a terminal, a workstation, or other such device.

ROM 24 provides non-volatile data storage for various application programs. In the example shown, a number of different application programs 32, 34, are stored in ROM 24. Also stored in ROM 24 is a user interface (UI) program 36 designed to work in concert with each of the application programs 32, 34. This is conceptually depicted by the UI program 36 shown as a layer on top of the application programs 32, 34. With such a design, UI program modules common to several application programs need not be duplicated in each of the application programs 32, 34. In addition, such a design may enable a common “look-and-feel” to the UI for the different program applications 32, 34. In other examples, the UI program, or module, is not a common program or module for more than one program application. In still other examples, the components described can be combined or separated in various manners, and can be stored in various manners, such as on various non-volatile storage medium.

Programs 32, 34, 36 have program instructions that can be loaded into RAM 22 during operation. Processor 20 then executes the program instructions, as required, to perform desired program functions.

Also stored in ROM 24 are various data in database 38. Database 38 includes data needed or generated during operation of the application programs 32, 34. Although only a single database 38 is shown that serves as a common database for all applications 32, 34, in other examples there can be separate databases for one, or more, of the applications 32, 34.

System 10 includes connection to a server 40 and a network interface 42, connected to its data bus 26. As such, system 10 can access server 40 over network 44 to run applications residing on the server 40. Network 44 can be, for example, a Local Area Network (LAN), Wide Area Network (WAN), or the Internet.

The server 40 includes a network interface 46, a processor 48, RAM 50, and ROM 52, all interconnected by a data bus 54. The server's network interface 46 provides the connection to network 44 so that client computer systems, such as system 10, can access the server 40. In similar fashion to computer system 10, the server ROM 52 includes various different application programs 56, 58, as well as a common user interface program 60 for the application programs 56, 58. ROM 52, in this example, includes data stored in database 62, although in other implementations separate databases or a separate database server may be required.

As an example, a table displayed on a UI is described using Web Dynpro from SAP AG. However, the methods described can be used in other UIs generated by other application programs. A Web Dynpro Table UI element enables a two-dimensional display of data in cells arranged into rows and columns. The table UI receives its data from multiple context nodes. At runtime, each node element of the node collection is a table row. The number of table rows is identical to the number of node elements. The table columns correspond to context attributes.

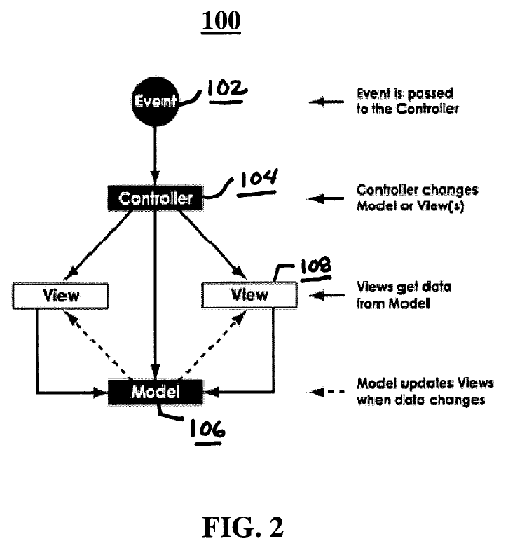

As shown in FIG. 2, an abstraction of a model view controller (MVC) 100 is a design pattern often used by software applications that need an ability to maintain multiple views of the same data. The MVC pattern 100 hinges on a clean separation of objects into one of three categories, i.e., models for maintaining data, views for displaying all or a portion of the data, and controllers for handling events that affect the model or view(s). Because of this separation, multiple views and controllers can interface with the same model. Even new types of views and controllers that never existed before can interface with a model without forcing a change in the model design.

Events 102 typically cause a controller 104 to change a model 106, or view 108, or both. Whenever the controller 104 changes a model's data or properties, all dependent views are automatically updated. Similarly, whenever the controller 104 changes a view 108, for example, by revealing areas that were previously hidden, the view 108 gets data from the underlying model 106 to refresh itself.

As described above, Web Dynpro is designed on the concept of a MVC. A model is any layer of software code that encapsulates some business functionality external to a Web Dynpro component. The model provides access to functionality such as Business Application Programming Interface (BAPI) calls or Web Services, and can be implemented, for example, as a set of proxy objects or Enterprise JavaBeans (EJB).

The controller acts as a binding layer between the model and the view layers. The controller has a context. A context is one hierarchical data storage structure for the controller. A context includes hierarchical arrangements of entities (e.g., data structures stored in memory) known as nodes and attributes. A node data structure can be a value node or model node. A value node holds the data itself, whereas a model node holds a reference to an external (model) object storing the data. A node is permitted to have children, an attribute is not. A node represents a collection. Each node has a collection of elements. Each element has a set of attributes. Each attribute element holds data. Nodes and attributes can be created at design time or at run time.

A view includes a set of user interface (UI) elements than can both display application data and receive input. UI elements are bound to a context that contains the data relevant in the view.

The context maintains and manages the data models and other data using the nodes, attributes and elements. The context is an important component to represent data in a view. Contexts receive data from a back end system, keep the data and manage the data. Contexts are also used to show data in the views.

A context is designed as a structured storage place for a MVC. As described above, a context has nodes and attributes. Attributes are always leafs in a tree data structure, which means that attributes do not have any children. A value node can contain data for UI elements. For example, a value code can be used for showing data in a Web Dynpro table. In this particular example, the attributes of the node are the columns of the table and the elements are the rows of the table.

Currently in Web Dynpro, a node does not have any type of “key” attribute, so there is no way to access elements quickly or directly. The only way to find a value of an element is to loop through each element of the node until the attribute value matches a value searched.

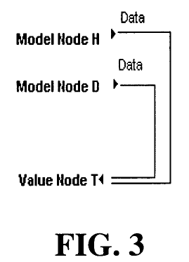

For example, a Web Dynpro table is bound to a node. As shown in FIG. 3, the node data are populated from model nodes. The model nodes are connected to the back end system. Often, the data of these nodes have to be combined in a table node in order to be displayed in a table.

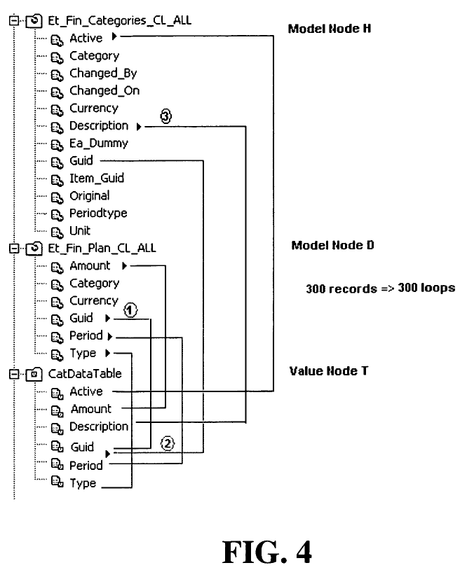

As shown in FIG. 4, assume a table node T includes data from two model nodes H and D. In this example, we assume that model node H contains “header” data for a financial category such as a description and an identification (ID) called “guid.” We also assume that table node D contains data for different periods in time and also the “guid.” In the table node T, a user desires to view the category description, status (active, inactive), and values for each period.

To populate table node T, a population process would first loop through model node D, for each element, copy the data needed for the table node, generate an element for the table node T, and populate the data copied from the model node D, including the guid. Second, the process would loop through the table node T, and for each element, copy the guid value. Lastly, the process would have to loop through model node H, and for each element, compare the guid value with the copied guid value, and if they match, copy the description and status of the element of model node H in the description and status of the table node T element that has the same guid.

As can be seen, this population process is costly in terms of performance when a large amount of data is involved and if more than two model nodes need to be combined. For example, if a table node has three hundred records or elements, the model node H loop three hundred times. This population process is speeded up when an element node is accessed directly by calling a value of a “key” attribute.

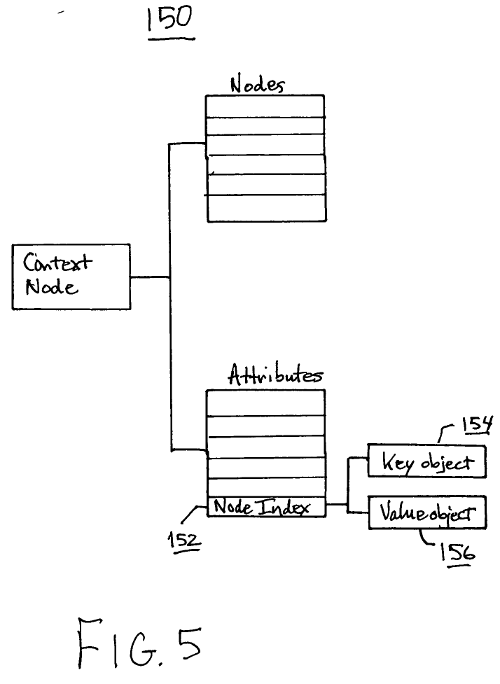

As shown in FIG. 5, a node index map 150 is generated and stored as an attribute in the context node and recalled at will when needed. Each key 152 in the node index map 150 includes a key object 154 representing a key attribute of an element and a value object 156 representing the element itself.

Using the example described above, we generate an attribute “Map A” that contains a map with “guid” for keys and for values of the elements of node A. An element of node A has an attribute “description” and an attribute “active.” We can now access an element and its attribute values directly by invoking its key, i.e., its guid.

A population process is now simplified to first, looping through model node D, and for each element, copy the data needed for the table node T, generate an element for the table node T, populate the data from the node D, including the guid, and second, using the node index map to directly get the description and the active status for the element having this guid as an index and populate the element of table node T with this data.

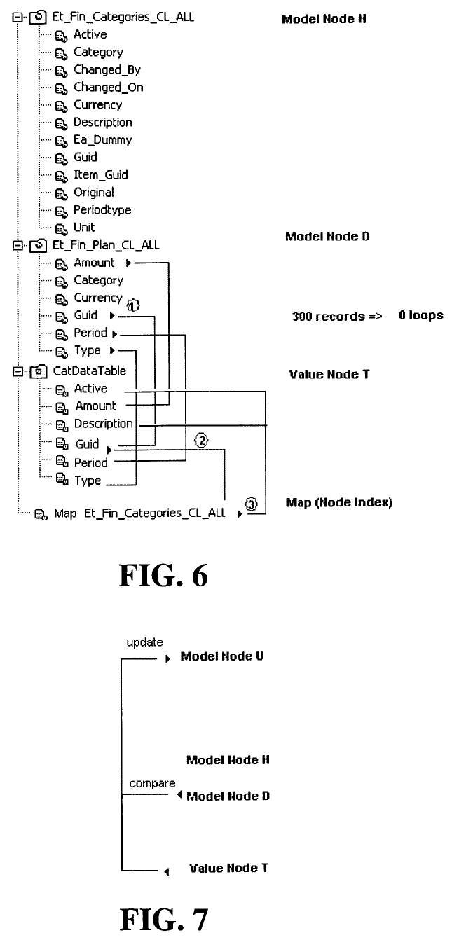

As shown in FIG. 6, the numbers of loops is drastically reduced over the number of loops described above without a node index map. For example, if we had three model nodes to search we reduce the number of loops by 2*300. In general, if the number of records in a table node is r and the number of model node is k, the number of loops is reduced by r*k.

As shown in FIG. 7, if some data is changed in the table and this updated data has to be transferred to a new model node U to update the back end system, the same performance problem can occur. Elements in the table node T need to be compared to the elements of the model node D to determine if some data has been changed and if so, the changed elements are transferred in the model node U for an update.

For the comparison of elements between node T and node D, for each element of node T, one would have to loop through the elements of node D. Using a node index map the number of loops is decreased. For example, if we had three hundred records, we can eliminate six hundred loops.

The process can be even simpler if the index node contains directly the element of the model node and not a copy of them. By updating the index node, the model node is automatically updated.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A memory for storing data for access by an application program being executed on a data processing system comprising:
a context node data structure stored in the memory, the context data structure comprising nodes and attributes, a selected attribute comprising a node index.

2. The memory of claim 1 wherein the node index comprises a key object and a value object.

3. The memory of claim 2 wherein the value object represents an object.

4. The memory of claim 2 wherein the key object represents a key attribute of an object.

5. A data processing system executing an application program and containing a database used by said application program, said data processing system comprising:
central processor unit (CPU) means for processing said application program; and
memory means for holding a data structure for access by said application program, said data structure being composed of information resident in said database used by said application program and including a context node data structure stored in the memory means, the context data structure comprising nodes and attributes, a selected attribute comprising a node index.

6. The data processing system of claim 5 wherein the node index comprises a key object and a value object.

7. The data processing system of claim 6 wherein the value object represents an object.

8. The data processing system of claim 6 wherein key object represents a key attribute of an object.
